(19) United States
(12) Patent Application Publication
(10) Pub. No.: US 2008/0247416 A1
(43) Pub. Date: Oct. 9, 2008

(54) CIRCUIT FOR TAPPING A LINE IN A NETWORK DIAGNOSTIC COMPONENT

(75) Inventors: Paul R. Gentieu, Sunnyvale, CA (US); Timothy M. Beyers, San Francisco, CA (US)

Correspondence Address: WORKMAN NYDEGGER, 60 EAST SOUTH TEMPLE, 1000 EAGLE GATE TOWER, SALT LAKE CITY, UT, 84111, US

(73) Assignee: Finisar Corporation, Sunnyvale, CA (US)

(21) Appl. No.: 11/696,621

(22) Filed: Apr. 4, 2007

(51) Int. Cl. H04J 3/22

(52) U.S. Cl. 370/465; 370/252

(57) ABSTRACT

The embodiments disclosed herein relate to a network diagnostic component and related circuit for tapping a line in the network diagnostic component. The network diagnostic component includes a first network port configured to connect with a first node, a second network port configured to connect with a second node and a connection line directly coupling the first network port to the second network port configured to transmit network traffic between the first and second networks port. The network diagnostic component further includes a tap circuit coupled to the connection line configured to obtain a portion of the network traffic transmitted between the first and second network ports via the connection line.

### CROSS-REFERENCE TO RELATED APPLICATIONS

Not applicable.

### BACKGROUND

Computer and data communications networks continue to develop and expand due to declining costs, improved performance of computer and networking equipment, and increasing demand for communication bandwidth. Communications networks, including for example, wide area networks (“WANs”), local area networks (“LANs”), and storage area networks (“SANs”) allow increased productivity and utilization of distributed computers or stations through the sharing of resources, the transfer of voice and data, and the processing of voice, data, and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks.

As the demand for networks has grown, network technology has grown to include many different physical configurations. Examples include Gigabit Ethernet, Fiber Distributed Data Interface (“FDDI”), Fibre Channel, and InfiniBand networks. These and the many other types of networks that have been developed typically utilize different cabling systems, different bandwidths and typically transmit data at different speeds. In addition, each of the different network types has different sets of standards, referred to as protocols, which set forth the rules for accessing the network and for communicating among the resources on the network.

Typically, transmissions between two network connected devices are passed through a hierarchy of protocol layers at each of the connected devices. Each layer in the first network connected device essentially carries on a conversation with a corresponding layer in the second network connected device, in accordance with an established protocol that defines the rules of communication between the layers.

As communication networks have increased in number, size and complexity however, they have become more likely to develop a variety of problems that are increasingly difficult to diagnose and resolve. Moreover, the demands for network operational reliability and increased network capacity, for example, emphasize the need for adequate diagnostic and remedial systems, methods and devices.

Example causes of network performance problems include the transmission of unnecessarily small frames of information, inefficient or incorrect routing of information, improper network configuration and superfluous network traffic, to name just a few. Such problems are aggravated by the fact that many networks are continually changing and evolving due to growth, reconfiguration and introduction of new network typologies and protocols, as well as the use of new interconnection devices and software applications.

Consequently, as high speed data communications mature, many designs increasingly focus on reliability and performance issues. In particular, communications systems have been designed to respond to a variety of network errors and problems, thereby minimizing the occurrence of network failures and downtimes. In addition, equipment, systems and methods have been developed that allow for the testing and monitoring of the ability of a communications system to respond to and deal with specific types of error conditions on a network. In general, such equipment, systems, and methods provide the ability to selectively alter channel data, including the introduction of errors into channel data paths.

One device that is used to detect these errors is a protocol analyzer, also called a network analyzer. A protocol analyzer runs in the background of a network, capturing, examining and logging packet traffic. Protocol analyzers can, for example, be configured to watch for unusual IP addresses, time stamps and data packets, and most have a user interface for enabling the network administrator to have access to information representing the analysis performed by the protocol analyzers. Protocol analyzers are thus a fundamental and highly useful tool for testing and debugging various types of communications networks, including computing and computer storage networks. A protocol analyzer operates by capturing selected portions of data from a data stream that is transmitted via the communications network. The captured information may then be analyzed in greater detail by the protocol analyzer to extract desired information. For instance, data transmission faults or errors, or performance errors, known generally as problem conditions, may be diagnosed by examining the captured data that is related to the problem. Hacking can also be detected through a protocol analyzer.

Referring to FIG. 1, a block diagram of a conventional protocol analyzer 130 is shown. As illustrated, protocol analyzer 130 is typically placed in-line between a device 110 and a device 120 so as to be able to be able to access network messages sent between the two devices. Devices 110 and 120 may be a server or host; a client or storage device; a switch; a hub; a router; all or a portion of a SAN fabric; a diagnostic device; and any device that may be coupled to a network and that may receive and/or monitor a signal or data over at least a portion of a network, that may send and/or generate a signal or data over at least a portion of a network, or both.

Network analyzer 130 includes a port 131 for receiving network traffic from and transmitting network traffic to device 110 and a port 132 for receiving network traffic from and transmitting network traffic to device 120. Typically, ports 131 and 132 are fanout buffer IC chips. Network analyzer 130 also includes a diagnostic module 135 which is generally configured to include the hardware and software that performs signal analysis on the network traffic.

In operation, port 131 receives network data from device 110. Port 131 then makes two copies of the received signal. One copy is sent to the diagnostic module for analysis while the second copy is sent to port 132 for transmission to device 120. In like manner, port 132 receives network data from device 120 and makes two copies of the signal. One copy is sent to the diagnostic module for analysis while the second copy is sent to port 131 for transmission to device 110. In this manner, network analyzer 130 is able analyze the network data between devices 110 and 120 while sitting passively between the devices.

While network analyzer 130 is sufficient for many applications, it also has several drawbacks that limit its usefulness in other applications. For example, the copy of the received network traffic provided by port 131 to port 132 or port 132 to port 131 is a regenerated signal. Often, this regenerated signal does not have the same amplitude as the received network traffic. Accordingly, the signal received by device 120 may not be the same as the signal sent by device 110. The same is true of the signal sent by device 120 and received by device 110. This change in signal amplitude is problematic for many applications where precision is required.

In addition, as the speed of the link between devices 110 and 120 increases, it is often difficult to obtain port 131 and 132 fanout buffer IC chips that are capable of handling these high speeds. For example, currently available port 131 and 132 fanout buffer IC chips may not be configured to copy and pass through certain types of signals from device 110 to device 120 or from device 120 to device 110. For instance, some communication protocols such as Serial Attached SCSI (“SAS”) and Serial ATA (“SATA”) often communicate using Out-Of-Band (OOB) signals. The OOB signals are used for initializing the speed of the link and resetting a device among other things. However, currently available port 131 and 132 fanout buffer IC chips are not configured to pass through SAS and SATA OOB signals and work at speeds of 6 Gbits/sec or higher. Accordingly, conventional network analyzers 130 may not be useful for higher speed SAS and SATA links.

Further, currently available fanout buffer ICs behave as nonlinear “limiting amplifiers.” Such amplifiers apply a large amount of gain to the input signal, with the result that all but the smallest input signal swings result in an output signal that has significant clipping at the buffer IC's minimum and maximum output voltages. This nonlinear behavior reduces or eliminates the effectiveness of equalization, a signal processing technique often used to compensate for increasing channel attenuation with frequency. For such equalization to be effective the entire channel (including buffer ICs) must be linear or have only a small amount of nonlinearity.

In applications operating with high-attenuation channels, such as backplanes or long cables, equalization is usually required to recover a bit stream successfully. Therefore, the use of nonlinear buffer ICs is often precluded in such applications.

A need therefore exists for a network analyzer or other network diagnostic component that eliminates or reduces the disadvantages and problems listed above and/or other disadvantages and problems.

### BRIEF SUMMARY

The embodiments disclosed herein relate to a network diagnostic component and related circuit for tapping a line in the network diagnostic component. The network diagnostic component includes a first network port configured to connect with a first node, a second network port configured to connect with a second node and a connection line directly coupling the first network port to the second network port configured to transmit network traffic between the first and second networks port

The network diagnostic component further includes a tap circuit coupled to the connection line configured to obtain a portion of the network traffic transmitted between the first and second network ports via the connection line.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be obvious from the description, or may be learned by the practice of the embodiments disclosed herein. The features and advantages of the embodiments disclosed herein may be realized and obtained by means of the instruments and combinations particularly pointed out in the appended claims. These and other features of the embodiments disclosed herein will become more fully apparent from the following description and appended claims, or may be learned by the practice of the embodiments disclosed herein as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a schematic diagram of a network analyzer in accordance with the prior art;

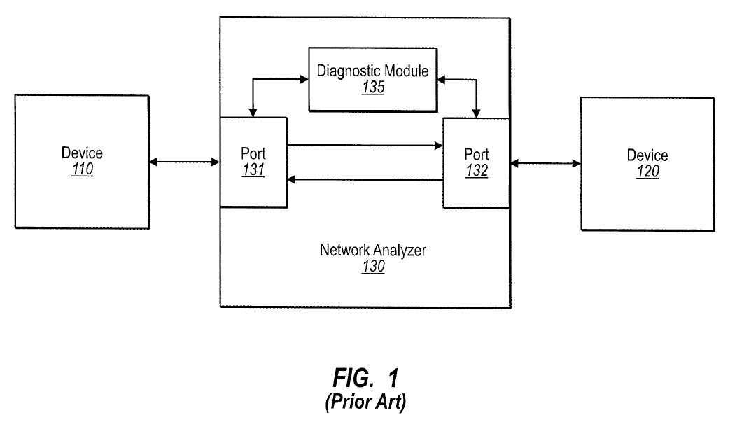

FIG. 2 illustrates a schematic of a network diagnostic component including a tap circuit in accordance with the principles of the present invention;

FIG. 3 illustrates a circuit diagram of a first embodiment of the tap circuit of FIG. 2; and

FIG. 4 illustrates a circuit diagram of a second embodiment of the tap circuit of FIG. 2.

### DETAILED DESCRIPTION

The embodiments disclosed herein relate to a network diagnostic component and related circuit for tapping a line in the network diagnostic component. The network diagnostic component includes a first network port configured to connect with a first node, a second network port configured to connect with a second node and a connection line directly coupling the first network port to the second network port configured to transmit network traffic between the first and second networks port.

The network diagnostic component further includes a tap circuit coupled to the connection line configured to obtain a portion of the network traffic transmitted between the first and second network ports via the connection line.

Certain embodiments relate generally to networking systems, including the testing of high speed data transmission systems and components. Embodiments of the invention may be used in other contexts unrelated to testing systems and components and/or in other contexts unrelated to high speed data transmission.

### Exemplary Networking System

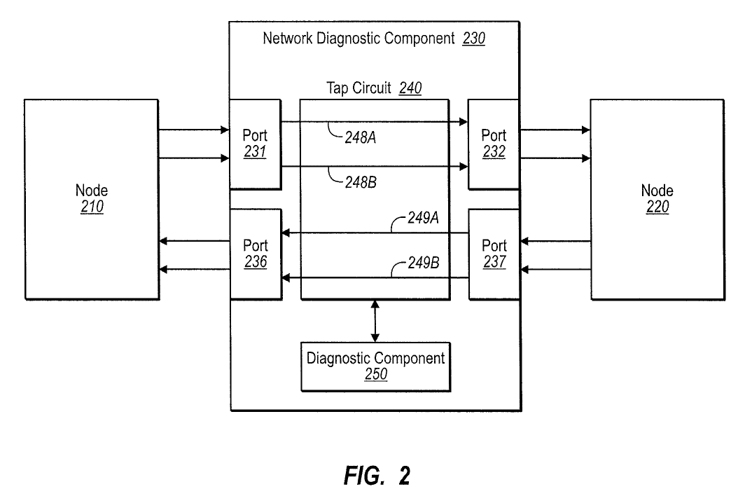

Referring to FIG. 2, a networking system 200 is illustrated. As shown, networking system 200 may include one or more nodes or devices, such as nodes 210 and 220, communicating with each other. As used herein, a “node” includes, but is not limited to, a server or host; a client or storage device; a switch; a hub; a router; all or a portion of a SAN fabric; a diagnostic device; and any device that may be coupled to a network and that may receive and/or monitor a signal or data over at least a portion of a network, that may send and/or generate a signal or data over at least a portion of a network, or both.

In one embodiment, a signal (such as, an electrical signal, an optical signal, and the like) may be used to send and/or receive network messages over at least a portion of a network. As used herein, a “network message” includes, but is not limited to, a packet; a datagram; a frame; a data frame; a command frame; an ordered set; any unit of data capable of being routed (or otherwise transmitted) through a computer network; and the like. In one embodiment, a network message may comprise transmission characters used for data purposes, protocol management purposes, code violation errors, and the like. Also, an ordered set may include, a Start of Frame (“SOF”), an End of Frame (“EOF”), an Idle, a Receiver_Ready (“R_RDY”), a Loop Initialization Primitive (“LIP”), an Arbitrate (“ARB”), an Open (“OPN”), and Close (“CLS”)—such as, those used in certain embodiments of Fibre Channel. Of course, any ordered sets and/or any network messages of any other size, type, and/or configuration may be used, including, but not limited to, those from any other suitable protocols.

Nodes 210 and 220 may communicate using suitable network protocols, including, but not limited to, serial protocols, physical layer protocols, channel protocols, packet-switching protocols, circuit-switching protocols, Ethernet, Fast Ethernet, Gigabit Ethernet, 10 Gigabit Ethernet, Fibre Channel, Fibre Channel Arbitrated Loop (“FC-AL”), Small Computer System Interface (“SCSI”), High Performance Parallel Interface (“HIPPI”), Serial Attached SCSI (“SAS”), Serial ATA (“SATA”), SAS/SATA, Serial SCSI Architecture (“SSA”), and the like.

### Exemplary Network Diagnostic Components

As shown in FIG. 2, the networking system 200 may comprise a network, a network diagnostic system, a network testing system, or the like; and the networking system 200 may include one or more network diagnostic components 230, which may perform variety of network diagnostic functions by way of a diagnostic module 250. The diagnostic component 230 may be configured to function as any combination of: a protocol or network analyzer, a monitor, and any other appropriate network diagnostic device. Note that diagnostic module 250 is generally configured to include the hardware and software that performs signal analysis on the network messages communicated between nodes 210 and 220.

### Protocol Analyzer

In some embodiments, the diagnostic component 230, along with the corresponding diagnostic module 250, may function as a protocol analyzer (or network analyzer), which may be used to capture data or a bit sequence for further analysis. The analysis of the captured data may, for example, diagnose data transmission faults, data transmission errors, performance errors (known generally as problem conditions), and/or other conditions.

The protocol analyzer may be configured to receive a bit sequence via one or more communication paths or channels. Typically, the bit sequence comprises one or more network messages, such as, packets, frames, or other protocol adapted network messages. The protocol analyzer preferably passively receives the network messages via passive network connections.

The protocol analyzer may be configured to compare the received the bit sequence (or at least a portion thereof) with one or more bit sequences or patterns. Before performing this comparison, the protocol analyzer may optionally apply one or more bit masks to the received bit sequence. In performing this comparison, the protocol analyzer may determine whether all or a portion of the received bit sequence (or the bit masked version of the received bit sequence) matches and/or does not match the one or more bit patterns. In one embodiment, the bit patterns and/or the bit masks may be configured such that the bit patterns will (or will not) match with a received bit sequence that comprises a network message having particular characteristics -- such as, for example, having an unusual network address, having a code violation or character error, having an unusual timestamp, having an incorrect CRC value, indicating a link re initialization, and/or having a variety of other characteristics.

The protocol analyzer may detect a network message having any specified characteristics, which specified characteristics may be user-selected via user input. It will be appreciated that a specified characteristic could be the presence of an attribute or the lack of an attribute. Also, it will be appreciated that the network analyzer may detect a network message having particular characteristics using any other suitable method.

In response to detecting a network message having a set of one or more characteristics, the network analyzer may execute a capture of a bit sequence -- which bit sequence may comprise network messages and/or portions of network messages. For example, in one embodiment, when the network analyzer receives a new network message, the network analyzer may buffer, cache, or otherwise store a series of network messages in a circular buffer. Once the circular buffer is filled, the network analyzer may overwrite (or otherwise replace) the oldest network message in the buffer with the newly received network message or messages. When the network analyzer receives a new network message, the network may detect whether the network message has a set of one or more specified characteristics. In response to detecting that the received network message has the one or more specified characteristics, the network analyzer may execute a capture (1) by ceasing to overwrite the buffer (thus capturing one or more network messages prior to detected message), (2) by overwriting at least a portion or percentage of the buffer with one or more newly received messages (thus capturing at least one network message prior to the detected message and at least network one message after the detected message), or (3) by overwriting the entire buffer (thus capturing one or more network messages after the detected message). In one embodiment, a user may specify via user input a percentage of the buffer to store messages before the detected message, a percentage of the buffer to store messages after the detected message, or both. In one embodiment, a protocol analyzer may convert a captured bit stream into another format.

In response to detecting a network message having a set of one or more characteristics, a network analyzer may generate a trigger adapted to initiate a capture of a bit sequence. Also, in response to receiving a trigger adapted to initiate a capture of a bit sequence, a network analyzer may execute a capture of a bit sequence. For example, the network analyzer may be configured to send and/or receive a trigger signal among a plurality of network analyzers. In response to detecting that a received network message has the one or more specified characteristics, a network analyzer may execute a capture and/or send trigger signal to one or more network analyzers that are configured to execute a capture in response to receiving such a trigger signal. Further embodiments illustrating trigger signals and other capture systems are described in U.S. patent application Ser. No. 10/881,620 filed Jun. 30, 2004 and entitled PROPAGATION OF SIGNALS BETWEEN DEVICES FOR TRIGGERING CAPTURE OF NETWORK DATA, which is hereby incorporated by reference herein in its entirety. Also, for example, a monitor (discussed in detail below) may be configured to generate a trigger adapted to initiate a capture of a bit sequence and may send that trigger to one or more network analyzers.

It will be appreciated that a capture may be triggered in response to detecting any particular circumstance—whether matching a bit sequence and bit pattern, receiving an external trigger signal, detecting a state (such as, when a protocol analyzer's buffer is filled), detecting an event, detecting a multi-network message event, detecting the absence of an event, detecting user input, or any other suitable circumstance.

The protocol analyzer may optionally be configured to filter network messages (for example, network messages having or lacking particular characteristics), such as, messages from a particular node, messages to a particular node, messages between or among a plurality of particular nodes, network messages of a particular format or type, messages having a particular type of error, and the like. Accordingly, using one or more bit masks, bit patterns, and the like, the protocol analyzer may be used identify network messages having particular characteristics and determine whether to store or to discard those network messages based at least in part upon those particular characteristics.

The protocol analyzer may optionally be configured to capture a portion of a network message. For example, the protocol analyzer may be configured to store at least a portion of a header portion of a network message, but discard at least a portion of a data payload. Thus, the protocol analyzer may be configured to capture and to discard any suitable portions of a network message.

It will be appreciated that a particular protocol specification may require network messages to have particular characteristics. Thus, a manufacturer of network nodes and the like may use the protocol analyzer to determine whether their goods comply with a protocol. Also, when nodes are deployed, the protocol analyzer may be used to identify defects in a deployed node or in other portions of a deployed network.

### Monitor

In some embodiments, the diagnostic component 230, along with the corresponding diagnostic module 250, may function as a monitor, which may be used to derive statistics from one or more network messages having particular characteristics, one or more conversations having particular characteristics, and the like.

As described below, the monitor may be configured to receive a bit sequence via one or more communication paths or channels. Preferably, the monitor passively receives the network messages via one or more passive network connections.

To determine the network messages and/or the conversations from which statistics should be derived, the monitor may be configured to compare a received a bit sequence—such as a network message—(or a portion of the received bit sequence) with one or more bit sequences or patterns. Before performing this comparison, the monitor may optionally apply one or more bit masks to the received bit sequence. In performing this comparison, the monitor may determine whether all or a portion of the received bit sequence (or the bit masked version of the received bit sequence) matches and/or does not match the one or more bit patterns. In one embodiment, the bit patterns and/or the bit masks may be configured such that the bit patterns will (or will not) match with a received bit sequence (or portion thereof) when the received bit sequence comprises a network message from a particular node, a network message to a particular node, a network message between or among a plurality of particular nodes, a network message of a particular format or type, a network message having a particular error, and the like. Accordingly, the monitor may be configured to detect a network message having any specified characteristics—including but not limited to whether the network message is associated with a particular conversation among nodes.

Upon detecting a network message having specified characteristics, the monitor may create and update table entries to maintain statistics for individual network messages and/or for conversations comprising packets between nodes. For example, a monitor may count the number of physical errors (such as, bit transmission errors, CRC error, and the like), protocol errors (such as, timeouts, missing network messages, retries, out of orders), other error conditions, protocol events (such as, an abort, a buffer is full message), and the like. Also, as an example, the monitor may create conversation specific statistics, such as, the number of packets exchanged in a conversation, the response times associated with the packets exchanged in a conversation, transaction latency, block transfer size, transfer completion status, aggregate throughput, and the like. It will be appreciated that a specified characteristic could be the presence of an attribute or the lack of an attribute.

In some embodiments, the diagnostic component 230 may include any features and/or perform any method described in U.S. patent application Ser. No. 10/769,202, entitled MULTI-PURPOSE NETWORK DIAGNOSTIC MODULES and filed on Jan. 30, 2004, which is hereby incorporated by reference herein in its entirety.

### Generator

In some embodiments, the diagnostic component 230, along with the corresponding diagnostic module 250, may function as a generator. The generator may generate and/or transmit a bit sequence via one or more communication paths or channels. Typically, the bit sequence comprises network messages, such as, packets, frames, or other protocol-adapted network messages. The network messages may comprise simulated network traffic between nodes on a network. In one embodiment, the bit sequence may be a predefined sequence of messages. Advantageously, a network administrator may evaluate how the nodes (and/or other nodes on the network) respond to the simulated network traffic. Thus, the network administrator may be able to identify performance deviations and take appropriate measures to help avoid future performance deviations.

In one embodiment, the generator may execute a script to generate the simulated network traffic. The script may allow the generator to dynamically simulate network traffic by functioning as a state machine or in any other suitable manner. For example, a script might include one or more elements like the following: “In state X, if network message A is received, transmit network message B and move to state Y.” The generator may advantageously recognize network messages (and any characteristics thereof) in any other suitable manner, including but not limited to how a protocol analyzer may recognize network messages (and any characteristics thereof). The script may also include a time delay instructing the generator to wait an indicated amount of time after receiving a message before transmitting a message in response. In response to receiving a message, a generator may transmit a response message that is completely predefined. However, in response to receiving a message, a generator may transmit a response message that is not completely predefined, for example, a response message that includes some data or other portion of the received message.

### Jammer

In some embodiments, the diagnostic component 230, along with the corresponding diagnostic module 250, may function as a jammer. The jammer may receive, generate, and/or transmit one or more bit sequences via one or more communication paths or channels. Typically, the bit sequences comprise network messages (such as, packets, frames, or other protocol-adapted network messages) comprising network traffic between nodes on a network. The jammer may be configured as an inline component of the network such that the jammer may receive and retransmit (or otherwise forward) network messages.

Prior to retransmitting the received network messages, the jammer may selectively alter at least a portion of the network traffic, which alterations may introduce protocol errors or other types of errors.

By altering at least a portion of the network traffic, the jammer may generate traffic, which traffic may be used to test a network. For example, a network administrator may then evaluate how the nodes on the network respond to these errors. For example, a network system designer can perform any one of a number of different diagnostic tests to make determinations such as whether a system responded appropriately to incomplete, misplaced, or missing tasks or sequences; how misdirected or confusing frames are treated; and/or how misplaced ordered sets are treated. In some embodiments, the network diagnostic component 130 may include any suitable jamming (or other network diagnostic system or method) disclosed in U.S. Pat. No. 6,268,808 B1 to Iryami et al., entitled HIGH SPEED DATA MODIFICATION SYSTEM AND METHOD, which is hereby incorporated by reference herein in its entirety.

In one embodiment, to determine which network messages to alter, the jammer may be configured to compare a received bit sequence—such as a network message—(or a portion of the received bit sequence) with one or more bit sequences or patterns. Before performing this comparison, the jammer may optionally apply one or more bit masks to the received bit sequence. In performing this comparison, the jammer may determine whether all or a portion of the received bit sequence (or the bit-masked version of the received bit sequence) matches and/or does not match the one or more bit patterns. In one embodiment, the bit patterns and/or the bit masks may be configured such that the bit patterns will (or will not) match with a received bit sequence (or portion thereof) when the received bit sequence comprises a network message from a particular node, a message to a particular node, a network message between or among a plurality of particular nodes, a network message of a particular format or type, and the like. Accordingly, the jammer may be configured to detect a network message having any specified characteristics. Upon detection of the network message having the specified characteristics, the jammer may alter the network message and/or one or more network messages following the network message.

### Example Tap circuit

As shown in FIG. 2, network diagnostic component 230 is placed in-line between nodes 210 and 220 so as to be able to receive and analyze the network messages sent between nodes 210 and 220. As illustrated, network diagnostic component 230 includes a port or connector 231 that is configured to receive network messages from node 210 over a line or connection 211A. Port 231 is also connected to a port or connector 232 by a line or connection 248A. Port 232 is then connected to node 220 by a line or connection 221A. Note that the ports or connectors 231 and 232 may be any suitable port or connector such as, but not limited to, SAS/SATA connectors, RJ-45 connectors, or the like. In some embodiments, nodes 210 and 220 may be connected by differential pair lines. In such embodiments, complementary signal line 211B connects node 210 to port or connector 231, complementary signal line 248B connects ports or connectors 231 and 232 and complementary signal line 221B connects port or connector 232 to node 220. Accordingly, the principles of the present invention contemplate both single ended and differential pair lines or connections.

As further illustrated in FIG. 2, network diagnostic component 230 further includes a port or connector 237 that is configured to receive network messages from node 220 over a line or connection 222A. Port 237 is also connected to a port or connector 236 by a line or connection 249A. Port 236 is also connected to node 210 by a line or connection 212A. Note that the ports or connectors 236 and 237 may be any suitable port or connector such as, but not limited to, SAS/SATA connectors, RJ-45 connectors, or the like. In some embodiments, nodes 210 and 220 may be connected by differential pair lines. In such embodiments, complementary signal line 212B is connects node 210 to port or connector 236, complementary signal line 249B connects ports or connectors 236 and 237 and complementary signal line 222B connects port or connector 237 to node 220. In some embodiments, lines 248A and 248B and lines 249A and 249B may be configured to be 50 ohm copper transmission lines, although other suitable transmission lines may also be implemented.

Network diagnostic component 230 may also include a tap circuit 240, as illustrated by the box surrounding lines 248 and 249. Tap circuit 240 may be configured to tap off or otherwise obtain a portion of the network traffic or messages sent between nodes 210 and 220 by taping lines 248A and 248B and lines 249A and 249B. Tap circuit 240 may then provide the portion of the network messages to diagnostic module 250 for analysis. Note that in some embodiments, network diagnostic module 250 may be configured to communicate with tap circuit 240 or to other portions of network diagnostic component 230. Specific examples of tap circuit 240 will follow.

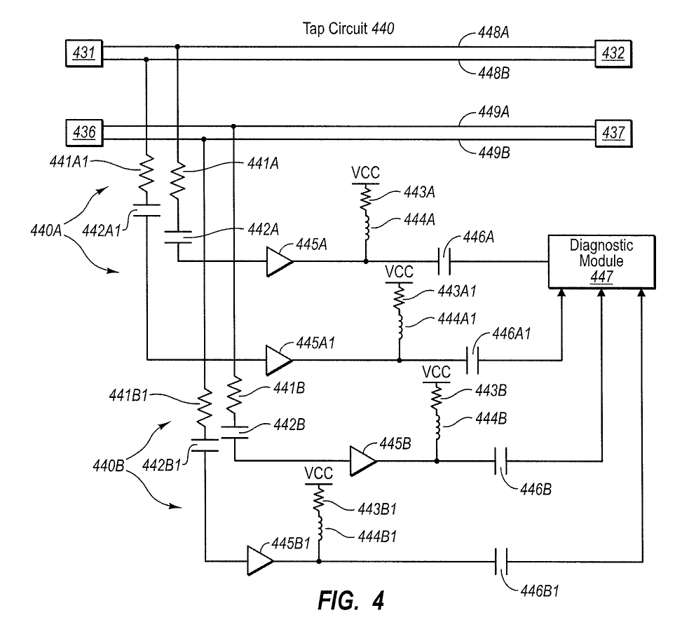

As mentioned previously, network diagnostic component 240 sets in-line between nodes 210 and 220. As shown in FIG. 4 and discussed previously, lines 248A and 248B physically connect ports 231 and 232 while lines 249A and 249B physically connect ports 236 and 237, which in turn provides a physical connection between nodes 210 and 220. Advantageously, this allows network traffic to be directly passed between nodes 210 and 220 without the need to make a copy as in the conventional analyzers discussed above. The use of tap circuit 240 advantageously allows for providing a sample of the network traffic to diagnostic component 250 while still maintaining the direct physical connection between nodes 210 and 220. Accordingly, network diagnostic component 130 is able to pass through OOB signals and other types of similar signals. Further, network diagnostic component 230 is not susceptible to the signal amplitude problems discussed previously. Additionally, use of tap circuit 240 allows network diagnostic component 230 to be used at higher speeds unsupported by currently available buffer ICs. Of course, use of tap circuit 240 allows network diagnostic component 230 to be used at lower speeds as well.

In some embodiments, network diagnostic component 230 may include one or more switches (not illustrated) that are coupled to one or more of lines 248A, 248B, 249A and 249B. Use of these switches, which may be any reasonable switch known to one of skill in the art, allow for network diagnostic module 250 to communicate directly to nodes 210 and 220. For example, the switches may be configured to create a direct link between diagnostic module 250 and one or both of nodes 210 and 220 while removing the direct link between the two nodes. This allows network diagnostic component 230 and network diagnostic module 250 to operate as a jammer and/or a generator.

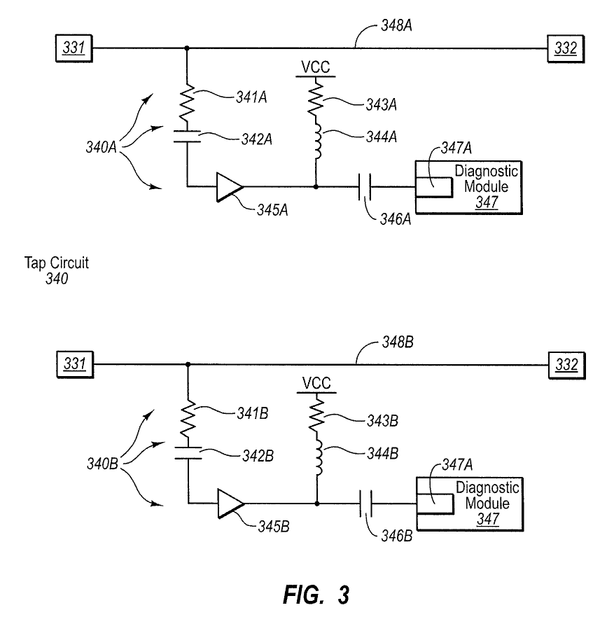

FIG. 3 schematically illustrates an example tap circuit 340 which may correspond to one particular embodiment of the tap circuit 240 of FIG. 2, although this is not required. Tap circuit 340 may contain one or more circuit portions, as illustrated by tap circuit portions 340A and 340B, depending on whether line 348 is a differential pair line or single ended line. For example, if the lines are single ended, then perhaps only one of the tap circuit portions 340A or 340B would be present. Alternatively, if the lines are differential pairs, then perhaps both tap circuit portions 340A and 340B would be present. Of course there may be more than two tap circuit portions as circumstances warrant. Note that in this description and in the claims, two components are considered coupled or connected to each other if either the two components are directly coupled to each other or they are indirectly coupled to each other through one or more intervening components.

As illustrated, in one embodiment tap circuit 340 may include tap circuit portion 340A. In this embodiment, tap circuit portion 340A includes ports or connectors 331 and 332, which may to correspond ports or connectors 231 and 232 of FIG. 2, that are physically connected by a line or connection 348A, which may correspond to line 248A of FIG. 2. In operation, port 331 receives network messages from node 210, passes the network messages to port 332 over line 348A. The messages are then provided by port 332 to node 220. Note that tap circuit portion 340A may contain additional elements not illustrated.

Tap portion 340A also includes a first resistor 341A having its top or first terminal coupled to line 348A and having its bottom or second terminal coupled to an input terminal of an amplifier 345A. In operation, the value of resistor 341A at least partially determines the size of the signal that is tapped off of line 348A and the amount that the signal on line 348A is attenuated. For example, the smaller the size of resistor 341A, the greater the strength of the signal tapped off of the line 348A and the greater that the signal on line 348A is attenuated. Accordingly, one skilled in the art after reading this description will appreciate that the value of resistor 341 A should be chosen such that enough signal strength is tapped off of line 348A while minimizing the attenuation of line 348A.

Typically, this is accomplished by choosing a value of resistor 341A that is large compared to the characteristic impedance of line 348A. For example, in one embodiment line 348A may be a 50 ohm line as previously mentioned. Accordingly, in this embodiment resistor 341A may be chosen to be about 200 ohms. This value for resistor 341A causes tap circuit 340A to tap off a signal that has approximately ⅕ of the amplitude of the signal on line 348A while only minimally attenuating the signal on line 348A. Of course, other values for resistor 341A may also be chosen as design and/or performance circumstances warrant.

As mentioned, resistor 341A feeds the tapped off signal to the input node of an RF linear amplifier 345A, which in this embodiment may have approximately a 50 ohm input impedance. RF linear amplifier 345A may be any suitable RF linear amplifier with a sufficient gain and bandwidth for the speed of the tapped signal. For example, in the present embodiment RF linear amplifier 345A may have sufficient gain to boost the ⅕ amplitude signal to full amplitude. In addition, in the present embodiment RF linear amplifier 345A may have a bandwidth that is able to handle high speed signals of about 3 GHz or higher. Note that in some embodiments, an AC coupling capacitor 342A, which may be any suitable capacitor, may be placed between resistor 341A and RF linear amplifier 345A for signal control purposes well known in the art. Note also that because RF linear amplifier 345A is linear, it is able to pass OOB and other such signals to the diagnostic module for analysis without adversely affecting the OOB signals.

In some embodiments, it is often necessary to bias RF linear amplifier 345A so that the amplifier has the proper bandwidth and does not oscillate at certain frequencies. Accordingly, tap circuit portion 340A includes a resistor 343A in series with an inductor 344A. As illustrated, the top or first terminal of resistor 343A is configured to be coupled to a voltage source VCC. The bottom or second terminal of resistor 343A is coupled to the top or first terminal of the inductor 344A, which has its bottom or second terminal coupled to the output terminal of RF linear amplifier 345A. In operation, the value of resistor 343A determines the amount of bias current provided to RF linear amplifier 345A. The value of resistor 343A may be determined by any reasonable means known to one skilled in the art. The value of inductor 344A, on the other hand, influences the bandwidth of RF linear amplifier 345A. For example, as will be appreciated by those skilled in the art, the impedance of inductor 344A rises with increasing frequency. As the impedance rises, the gain of the amplifier rises as well. Accordingly, inductor 344A has the effect of slightly boosting the amplifier gain at higher frequencies from where the amplifier gain would normally be without the use of inductor 344A. This can help compensate for high-frequency losses in other parts of tap portion 340, such as the traces on the printed circuit board. Of course, as will be appreciated by one of skill in the art, the value of inductor 344A typically should be chosen such that parasitic capacitance is small at the maximum frequency of interest.

Returning to FIG. 3, the amplified signal is then provided by the output node of RF linear amplifier 345A to diagnostic module 347. Diagnostic module 347 may correspond to diagnostic module 250 of FIG. 2 and may function as previously described. In some embodiments, a SERDES chip or other port 347A may act as an interface between RF linear amplifier 345A and diagnostic nodule 347. Note that in some embodiments, an AC coupling capacitor 346A, which may be any suitable capacitor, may be placed between RF linear amplifier 345A and diagnostic module 347 for signal control purposes well known in the art.

As mentioned above, in some embodiments line 348 may also be implemented as a differential pair. In such embodiments tap circuit 340 may also include tap circuit portion 340B. In this embodiment, tap circuit portion 340B includes ports or connectors 331 and 332, which may correspond ports or connectors 231 and 232 of FIG. 2. The two ports are physically connected by line or connection 348B, which may represent the complimentary signal line of the differential signal pair comprising lines 348A and 348B. In operation, port 332 receives network messages from node 210, passes the network messages to port 332 over line 348B. The messages are then provided by port 332 to node 220. Note that tap circuit portion 340B may contain additional elements not illustrated.

Tap portion 340B also includes a first resistor 341B having its top or first terminal coupled to line 348B and having its bottom or second terminal coupled to an input terminal of an amplifier 345B. In operation, the value of resistor 341B at least partially determines the size of the signal that is tapped off of line 348B and the amount that the signal on line 348A is attenuated. For example, the smaller the size of resistor 341B, the greater the strength of the signal tapped off of the line 348B and the greater that the signal on line 348B is attenuated. Accordingly, one skilled in the art after reading this description will appreciate that value of resistor 341B should be chosen such that enough signal strength is tapped off of line 348B while minimizing the attenuation of line 348B.

Typically, this is accomplished by choosing a value of resistor 341B that is large compared to the characteristic impedance of line 348B. For example, in one embodiment line 348B may be a 50 ohm line. Accordingly, in this embodiment resistor 341B may be chosen to be about 200 ohms. This value for resistor 341B causes tap circuit 340B to tap off a signal that has approximately ⅕ of the amplitude of the signal on line 348B while only minimally attenuating the signal on line 348B. Of course, other values for resistor 341B may also be chosen as design and/or performance circumstances warrant.

As mentioned, resistor 341B feeds the tapped off signal to the input node of an RF linear amplifier 345B, which in this embodiment may have approximately a 50 ohm input impedance. RF linear amplifier 345B may be any suitable RF linear amplifier with a sufficient gain and bandwidth for the speed of the tapped signal. For example, in the present embodiment RF linear amplifier 345B may have sufficient gain to boost the ⅕ amplitude signal to full amplitude. In addition, in the present embodiment RF linear amplifier 345B may have a bandwidth that is able to handle high speed signals of about 3 GHz or higher. Note that in some embodiments, an AC coupling capacitor 342B, which may be any suitable capacitor, may be placed between resistor 341B and RF linear amplifier 345B for signal control purposes well known in the art. Note also that because RF linear amplifier 345B is linear, it is able to pass OOB and other such signals to the diagnostic module for analysis without adversely affecting the OOB signals. In some embodiments, RF linear amplifiers 345A and 345B may be the same amplifier.

In some embodiments, it is often necessary to bias RF linear amplifier 345B so that the amplifier has the proper bandwidth and does not oscillate at certain frequencies. Accordingly, tap circuit portion 340B includes a resistor 343B in series with an inductor 344B. As illustrated, the top or first terminal of resistor 343B is configured to be coupled to a voltage source VCC. The bottom or second terminal of resistor 343B is coupled to the top or first terminal of the inductor 344B, which has its bottom or second terminal coupled to the output terminal of RF linear amplifier 345A. In operation, the value of resistor 343A determines the amount of bias current provided to RF linear amplifier 345B. The value of resistor 343B may be determined by any reasonable means known to one skilled in the art. The value of inductor 344B, on the other hand, influences the bandwidth of RF linear amplifier 345B. For example, as will be appreciated by those skilled in the art, the impedance of inductor 344A rises with increasing frequency. As the impedance rises, the gain of the amplifier rises as well. Accordingly, inductor 344A has the effect of slightly boosting the amplifier gain at higher frequencies from where the amplifier gain would normally be without the use of inductor 344A. This can help compensate for high-frequency losses in other parts of tap portion 340, such as the traces on the printed circuit board. Of course, as will be appreciated by one of skill in the art, the value of inductor 344A typically should be chosen such that parasitic capacitance is small at the maximum frequency of interest.

Returning to FIG. 3, the amplified signal is then provided by the output node of RF linear amplifier 345B to diagnostic module 347 as previously discussed. Note that in some embodiments, an AC coupling capacitor 346B, which may be any suitable capacitor, may be placed between RF linear amplifier 345B and diagnostic module 347 for signal control purposes well known in the art.

As mentioned in relation to FIG. 2, signal line 249 may be implemented as a single ended line or as a differential pair. Although not illustrated, a single ended line 249 would have a tap circuit that is functionally equivalent to the tap circuit discussed above in relation to tap portion 340A of FIG. 3. Likewise, if line 249 were implemented as a differential pair, then the complementary signal line of the differential pair would have a tap circuit that is functionally equivalent to the tap circuit discussed in relation to tap portion 340B of FIG. 3.

FIG. 4 illustrates as an additional embodiment a tap circuit 440, which may correspond to tap circuit 240, although this is not required. In FIG. 4, ports 431, 432, 436, and 437 may correspond to ports 231, 232, 236, and 237 respectively of FIG. 2, while lines 448A, 448B, 449A and 449B may correspond to lines 248A, 248B, 249A and 249B respectively, although this not required. Note that tap circuit 440 may contain additional elements not illustrated.

Referring to FIG. 4, tap circuit 440 includes a circuit portion 440A that may include a first tap circuit that includes a resistor 441A having its top terminal coupled to line 448A and its bottom terminal coupled to a RF linear amplifier 445A. In some embodiments, an AC coupling capacitor 442A may be placed between resistor 441A and RF linear amplifier 445A. Further, circuit portion 440A includes a resistor 443A having its top terminal coupled to a voltage source VCC and its bottom terminal coupled to a top terminal of an inductor 444A. The bottom terminal of inductor 444A is coupled to the output of RF linear amplifier 445A. The output of RF linear amplifier 445A is coupled to diagnostic module 447. In some embodiments, an AC coupling capacitor 446A may be placed between RF linear amplifier 445A and diagnostic module 447.

Likewise, tap circuit portion 440A further includes a second tap circuit that includes a resistor 441A1 having its top terminal coupled to complementary line 448B and its bottom terminal coupled to a RF linear amplifier 445A1. In some embodiments, an AC coupling capacitor 442A1 may be placed between resistor 441A1 and RF linear amplifier 445A1. Further, circuit portion 440A includes a resistor 443A1 having its top terminal coupled to voltage source VCC and its bottom terminal coupled to a top terminal of an inductor 444A1. The bottom terminal of inductor 444A1 is coupled to the output of RF linear amplifier 445A1. The output of RF linear amplifier 445A1 is coupled to diagnostic module 447. In some embodiments, an AC coupling capacitor 446A1 may be placed between RF linear amplifier 445A1 and diagnostic module 447. The operation and functions of the two tap circuits of circuit portion 440A and the components comprising the two tap circuits of circuit portion 440A are equivalent to those described in relation to tap circuit portions 340A and 340B of FIG. 3 and need not be described again. In addition, the values of the components of circuit portion 440A may be chosen as previously described in relation to tap circuit portions 340A and 340B. Note that in some embodiments, amplifiers 445A and 445A1 may be implemented as a single IC package.

In similar manner, tap circuit 440 includes a circuit portion 440B that may include a first tap circuit that may include a resistor 441B having its top terminal coupled to line 449A and its bottom terminal coupled to a RF linear amplifier 445B. In some embodiments, an AC coupling capacitor 442B may be placed between resistor 441B and RF linear amplifier 445B. Further, circuit portion 440B includes a resistor 443B having its top terminal coupled to a voltage source VCC and its bottom terminal coupled to a top terminal of an inductor 444B. The bottom terminal of inductor 444B is coupled to the output of RF linear amplifier 445B. The output of RF linear amplifier 445B is coupled to diagnostic module 447. In some embodiments, an AC coupling capacitor 446B may be placed between RF linear amplifier 445B and diagnostic module 447.

Likewise, tap circuit portion 440B further includes a second tap circuit that includes a resistor 441B1 having its top terminal coupled to complementary line 449B and its bottom terminal coupled to a RF linear amplifier 445B1. In some embodiments, an AC coupling capacitor 442B1 may be placed between resistor 441B1 and RF linear amplifier 445B1. Further, circuit portion 440B includes a resistor 443B1 having its top terminal coupled to voltage source VCC and its bottom terminal coupled to a top terminal of an inductor 444B1. The bottom terminal of inductor 444B1 is coupled to the output of RF linear amplifier 445B1. The output of RF linear amplifier 445B1 is coupled to diagnostic module 447. In some embodiments, an AC coupling capacitor 446B1 may be placed between RF linear amplifier 445B1 and diagnostic module 447. The operation and functions of the two tap circuits of circuit portion 440B and the components comprising the two tap circuits of circuit portion 440B are equivalent to those described in relation to tap circuit portions 340A and 340B of FIG. 3 and need not be described again. In addition, the values of the components of circuit portion 440B may be chosen as previously described in relation to tap circuit portions 340A and 340B. Note that in some embodiments, amplifiers 445B and 445B1 may be implemented as a single amplifier.

Accordingly, embodiments disclosed herein relate to a circuit for tapping a line in a network diagnostic component such as a protocol or network analyzer. Advantageously, the tap circuit allows for the network traffic to be directly passed between nodes or devices without the need to make a copy as in conventional analyzers. The use of the tap circuit also advantageously allows for providing a sample of the network traffic to the diagnostic component while still maintaining the direct physical connection between nodes. Accordingly, network the diagnostic component is able to pass through OOB signals and other types of similar signals while being used at higher speeds such as 6 Gbits/sec or above that are unsupported by currently available fanout buffer ICs.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We Claim:

1. A network diagnostic component comprising:
a first network port configured to connect with a first node;
a second network port configured to connect with a second node;
a connection line directly coupling the first network port to the second network port configured to transmit network traffic between the first and second networks ports; and
a tap circuit coupled to the connection line configured to obtain a portion of the network traffic transmitted between the first and second network ports via the connection line.

2. The network diagnostic component in accordance with claim 1, further comprising a diagnostic module coupled to the tap circuit, wherein the diagnostic module is configured to receive the portion of the network traffic obtained by the tap circuit and to provide analysis of the network traffic.

3. The network diagnostic component in accordance with claim 2, wherein the network diagnostic module performs analysis comprising one of analyzing, monitoring, jamming, or generation.

4. The network diagnostic component in accordance with claim 1, wherein the network diagnostic component is one of a network or protocol analyzer, a monitor, a jammer, or a generator.

5. The network diagnostic component in accordance with claim 1, wherein the connection line comprises a 50 ohm transmission line.

6. The network diagnostic component in accordance with claim 1, wherein the tap circuit comprises:
a first resistor having a first terminal coupled to the connection line, the first resistor configured to obtain a portion of the network traffic transmitted between the first and second network ports; and
an RF linear amplifier having an input coupled to a second terminal of the first resistor and having an output coupled to a diagnostic module of the network diagnostic component, wherein the RF linear amplifier is configured to provide amplification to the obtained portion of the network traffic and to have a sufficient bandwidth to handle the obtained portion of the network traffic.

7. The network diagnostic component in accordance with claim 6, wherein the tap circuit further comprises:
a second resistor having a first terminal configured to be coupled to a voltage source, wherein the second resistor is configured to at least partially control a bias signal provided to the RF linear amplifier; and
an inductor having a first terminal coupled to a second terminal of the second resistor and having a second terminal coupled to the output of the RF linear amplifier, wherein the inductor is configured to at least partially influence the bandwidth of the RF linear amplifier.

8. The network diagnostic component in accordance with claim 6, wherein the value of the first resistor determines the portion of the network traffic obtained and an amount of attenuation for the network traffic being transmitted on the connection line.

9. The network diagnostic component in accordance with claim 8, wherein the first resistor is a 200 ohm resistor.

10. The network diagnostic component in accordance with claim 7, wherein the tap circuit further comprises:
a first AC coupling capacitor having a first terminal coupled to the second terminal of the first resistor and having a second terminal coupled to the input of the RF linear amplifier; and
a second AC coupling capacitor having a first terminal coupled to the output of the RF linear amplifier and to the input of the diagnostic module.

11. The network diagnostic component in accordance with claim 1, wherein the connection line is a first connection line and the tap circuit is a first tap circuit, the network diagnostic component further comprising:
a second connection line that is complimentary of the first connection line directly coupling the first network port to the second network port configured to transmit network traffic between the first and second networks ports; and
a second tap circuit coupled to the connection configured to obtain a portion of the network traffic transmitted between the first and second network ports via the second connection line.

12. The network diagnostic component in accordance with claim 11, wherein the second tap circuit comprises:
a first resistor having a first terminal coupled to the second connection line, the first resistor configured to obtain a portion of the network traffic transmitted between the first and second network ports; and
an RF linear amplifier having an input coupled to a second terminal of the first resistor and having an output coupled to a diagnostic module of the network diagnostic component, wherein the RF linear amplifier is configured to provide amplification to the obtained portion of the network traffic and to have a sufficient bandwidth to handle the obtained portion of the network traffic.

13. The network diagnostic component in accordance with claim 12, wherein the value of the first resistor determines the portion of the network traffic obtained from the second connection line and an amount of attenuation for the network traffic being transmitted on second the connection line.

14. The network diagnostic component in accordance with claim 12, wherein the second tap circuit further comprises:
a second resistor having a first terminal configured to be coupled to a voltage source, wherein the second resistor is configured to at least partially control a bias signal provided to the RF linear amplifier; and
an inductor having a first terminal coupled to a second terminal of the second resistor and having a second terminal coupled to the output of the RF linear amplifier, wherein the inductor is configured to at least partially influence the bandwidth of the RF linear amplifier;
a first AC coupling capacitor having a first terminal coupled to the second terminal of the first resistor and having a second terminal coupled to the input of the RF linear amplifier; and
a second AC coupling capacitor having a first terminal coupled to the output of the RF linear amplifier and to the input of the diagnostic module.

15. The network diagnostic component in accordance with claim 1, wherein the network diagnostic component is configured to pass through Out-Of-Band signals when operated at speeds of 6 Gbits/sec or higher.

16. A network diagnostic component comprising:
a first network port configured to connect with a first node;
a second network port configured to connect with a second node;
a first connection line directly coupling the first network port to the second network port;
a second connection line that is complementary of the first connection line directly coupling the first network port to the second network port; wherein the first and second connection lines are configured to transmit network traffic between the first and second networks ports; and
a tap circuit coupled to the first and second connection lines configured to obtain a portion of the network traffic transmitted between the first and second network ports via the first and second connection lines.

17. The network diagnostic component in accordance with claim 16, wherein the tap circuit comprises:
a first resistor having a first terminal coupled to the first connection line, the first resistor configured to obtain a first portion of the network traffic transmitted between the first and second network ports via the first connection line;
a first RF linear amplifier having an input coupled to a second terminal of the first resistor and having an output coupled to a diagnostic module of the network diagnostic component, wherein the first RF linear amplifier is configured to provide amplification to the obtained first network traffic portion and to have a sufficient bandwidth to handle the obtained first portion of the network traffic;
a second resistor having a first terminal coupled to the second connection line, the second resistor configured to obtain a second portion of the network traffic transmitted between the first and second network port via the second connection line; and
a second RF linear amplifier having an input coupled to a second terminal of the second resistor and having an output coupled to the diagnostic module of the network diagnostic component, wherein the second RF linear amplifier is configured to provide amplification to the obtained second portion of the network traffic and to have a sufficient bandwidth to handle the obtained second portion of the network traffic.

18. The network diagnostic component in accordance with claim 16, wherein the tap circuit is a first tap circuit, the network diagnostic component further comprising:
a third network port configured to connect with the first node;
a fourth network port configured to connect with the second node;
a third connection line directly coupling the first network port to the second network port;
a fourth connection line that is complementary of the third connection line if directly coupling the third network port to the fourth network port; wherein the third and fourth connection lines are configured to transmit network traffic between the third and fourth networks ports; and
a second tap circuit coupled to the third and fourth connection lines configured to obtain a portion of the network traffic transmitted between the third and fourth network ports via the third and fourth connection lines.

19. The network diagnostic component in accordance with claim 18, wherein the second tap comprises:
a first resistor having a first terminal coupled to the third connection line, the first resistor configured to obtain a first portion of the network traffic transmitted between the third and fourth network ports via the third connection line;
a first RF linear amplifier having an input coupled to a second terminal of the first resistor and having an output coupled to a diagnostic module of the network diagnostic component, wherein the first RF linear amplifier is configured to provide amplification to the obtained first network traffic portion and to have a sufficient bandwidth to handle the obtained first portion of the network traffic;
a second resistor having a first terminal coupled to the fourth connection line, the second resistor configured to obtain a second portion of the network traffic transmitted between the third and fourth network ports via the fourth connection line; and
a second RF linear amplifier having an input coupled to a second terminal of the third resistor and having an output coupled to the diagnostic module of the network diagnostic component, wherein the second RF linear amplifier is configured to provide amplification to the obtained second portion of the network traffic and to have a sufficient bandwidth to handle the obtained second portion of the network traffic.

20. A network diagnostic component comprising:
a first network port configured to connect with a first node;
a second network port configured to connect with a second node;
a third network port configured to connect with the first node;
a fourth network port configured to connect with the second node;
a first connection line directly coupling the first network port to the second network port;
a second connection line that is complementary of the first connection line directly coupling the first network port to the second network port; wherein the first and second connection lines are configured to transmit network traffic between the first and second networks ports;
a third connection line directly coupling the third network port to the fourth network port;
a fourth connection line that is complementary of the third connection line directly coupling the third network port to the fourth network port; wherein the third and fourth connection lines are configured to transmit network traffic between the third and fourth networks ports; and
a tap circuit coupled to the first, second, third, and fourth connection lines configured to obtain a portion of the network traffic transmitted between the first and second network ports via the first and second connection lines and configured to obtain a portion of the network traffic transmitted between the third and fourth networks ports via the third and fourth connection lines.

21. The network diagnostic component in accordance with claim 20, wherein the tap circuit comprises:
a first tap circuit portion coupled to the first and second connection lines, the first tap circuit portion configured to obtain a portion of the network traffic transmitted via the first and second connection lines; and
a second tap circuit portion coupled to the third and fourth connection lines, the second tap circuit portion configured to obtain a portion of the network traffic transmitted via the third and fourth connection lines.

22. The network diagnostic component in accordance with claim 21, wherein the first tap portion comprises:
a first resistor having a first terminal coupled to the first connection line, the first resistor configured to obtain a first portion of the network traffic transmitted between the first and second network ports via the first connection line;
a first RF linear amplifier having an input coupled to a second terminal of the first resistor and having an output coupled to a diagnostic module of the network diagnostic component, wherein the first RF linear amplifier is configured to provide amplification to the first obtained network traffic portion and to have a sufficient bandwidth to handle the obtained first portion of the network traffic;
a second resistor having a first terminal configured to be coupled to a voltage source, wherein the second resistor is configured to at least partially control a bias signal provided to the first RF linear amplifier;
a first inductor having a first terminal coupled to a second terminal of the second resistor and having a second terminal coupled to the output of the first RF linear amplifier, wherein the first inductor is configured to at least partially influence the bandwidth of the RF linear amplifier;
a third resistor having a first terminal coupled to the second connection line, the third resistor configured to obtain a second portion of the network traffic transmitted between the first and second network port via the second connection line;
a second RF linear amplifier having an input coupled to a second terminal of the third resistor and having an output coupled to the diagnostic module of the network diagnostic component, wherein the second RF linear amplifier is configured to provide amplification to the obtained second portion of the network traffic and to have a sufficient bandwidth to handle the obtained second portion of the network traffic;
a fourth resistor having a first terminal configured to be coupled to the voltage source, wherein the fourth resistor is configured to at least partially control a bias signal provided to the second RF linear amplifier; and
a second inductor having a first terminal coupled to a second terminal of the fourth resistor and having a second terminal coupled to the output of the second RF linear amplifier, wherein the second inductor is configured to at least partially influence the bandwidth of the RF linear amplifier.

23. The network diagnostic component in accordance with claim 21, wherein the second tap portion comprises:
a first resistor having a first terminal coupled to the third connection line, the first resistor configured to obtain a first portion of the network traffic transmitted between the first and second network ports via the third connection line;
a first RF linear amplifier having an input coupled to a second terminal of the first resistor and having an output coupled to a diagnostic module of the network diagnostic component, wherein the first RF linear amplifier is configured to provide amplification to the first obtained network traffic portion and to have a sufficient bandwidth to handle the obtained first portion of the network traffic;
a second resistor having a first terminal configured to be coupled to a voltage source, wherein the second resistor is configured to at least partially control a bias signal provided to the first RF linear amplifier;
a first inductor having a first terminal coupled to a second terminal of the second resistor and having a second terminal coupled to the output of the first RF linear amplifier, wherein the first inductor is configured to at least partially influence the bandwidth of the RF linear amplifier;
a third resistor having a first terminal coupled to the fourth connection line, the third resistor configured to obtain a second portion of the network traffic transmitted between the first and second network port via the fourth connection line;
a second RF linear amplifier having an input coupled to a second terminal of the third resistor and having an output coupled to the diagnostic module of the network diagnostic component, wherein the second RF linear amplifier is configured to provide amplification to the obtained second portion of the network traffic and to have a sufficient bandwidth to handle the obtained second portion of the network traffic;
a fourth resistor having a first terminal configured to be coupled to the voltage source, wherein the fourth resistor is configured to at least partially control a bias signal provided to the second RF linear amplifier; and
a second inductor having a first terminal coupled to a second terminal of the fourth resistor and having a second terminal coupled to the output of the second RF linear amplifier, wherein the second inductor is configured to at least partially influence the bandwidth of the RF linear amplifier.
